(19) United States
(12) Patent Application Publication
(10) Pub. No.: US 2005/0092969 A1
(43) Pub. Date: May 5, 2005

(54) Method of stabilizing compound having quinone skeleton and stabilized composition

(75) Inventors: Takahiro Ueda, Kobe-shi (JP); Shiro Kitamura, Akashi-shi (JP); Yasuyoshi Ueda, Himeji-shi (JP)

Correspondence Address: SUGHRUE MION, PLLC, 2100 PENNSYLVANIA AVENUE, N.W., SUITE 800, WASHINGTON, DC, 20037, US

(73) Assignee: KANEKA CORPORATION

(21) Appl. No.: 10/959,052

(22) Filed: Oct. 7, 2004

Related U.S. Application Data
(60) Provisional application No. 60/563,834, filed on Apr. 21, 2004.

(30) Foreign Application Priority Data
Oct. 8, 2003 (JP) 2003-349964
Apr. 12, 2004 (JP) 2004-117150

(51) Int. Cl. C09K 15/04

(52) U.S. Cl. 252/399

(57) ABSTRACT

The present invention has for its object to provide a method of stabilizing a compound having a quinone skeleton in the state that the compound having a quinone skeleton and an antioxidant being coexisted, and a composition containing a stabilized compound having a quinone skeleton. The present invention relates to a method of stabilizing a compound having a quinone skeleton in a composition comprising a compound having a quinone skeleton and an antioxidant which comprises coating at least one of said compound having a quinone skeleton and an antioxidant with an oil-insoluble coating medium to make both constituents coexist in an oily substance, or coating at least one of said compound having a quinone skeleton and an antioxidant with a water-insoluble coating medium to make both constituents coexist in an aqueous substance, and a composition containing a compound comprising a quinone skeleton. According to the present invention, the compound having a quinone skeleton can be stably retained even the compound having a quinone skeleton and an antioxidant being coexisted.

### TECHNICAL FIELD

The present invention relates to a method of stabilizing a composition comprising a compound having a quinone skeleton. Ubidecarenones are useful compounds as good foods, functional nutritive foods, specified health foods, nutritional supplements, nutrients, veterinary drugs, beverages, feedstuff, cosmetic products, pharmaceutical products, therapeutic agents, preventive drugs, and the like.

### BACKGROUND ART

Coenzyme Q (ubiquinones), vitamin K, plastoquinones, pyrroloquinoline quinones, etc., which are compounds having a quinone skeleton, are known to play important roles in biological reactions.

For example, coenzyme Q (ubiquinones) which are benzoquinone derivatives distributed broadly in the biological world are indispensable substances in living bodies from bacteria to mammals, and are known as a component of the electron transport system of mitochondria within the cells of living bodies. It is also known that coenzyme Q functions as an electron carrier in the electron transport system through repeating the cycle of oxidation-reduction in mitochondria. As the physiological actions of coenzyme Q, there have been mentioned the activation of energy production through activation of mitochondria, activation of cardiac function, stabilization of cell membranes, cytoprotection through its antioxidant activity, and the like. In humans, coenzyme Q₁₀ having 10 isoprene units is the main component, and normally about 40 to 90% of the substance is present in the reduced form in living bodies.

Among them, coenzyme Q₁₀ is also called ubidecarenone, and has been in use as a health food in Europe and the United States, and recently been used as a nutritional supplement in Japan as well. Furthermore, based on its vitamin-like function, coenzyme Q₁₀ is also called vitamin Q, and is a rejuvenating substance as a nutrient source capable of restoring the weakened cell activity to the healthy state. Coenzyme Q₁₀ is localized in mitochondria, lysosomes, Golgi apparatus, microsomes, peroxisomes, cell membranes, etc. And as a constituent component of the electron transport system, coenzyme Q₁₀ is an indispensable substance for the maintenance of living body functions for known to be involved in activation of ATP production, antioxidant activity in living bodies, and membrane stabilization.

Vitamin K, the generic name for 2-methyl-1,4-naphthoquinone derivatives having blood-coagulation activity, is also known as an indispensable component in living bodies. Vitamin K1 (phylloquinone), for example, has a phytyl side chain in 3-position and is known as the sole vitamin K homolog compound in plants. While vitamin K2 has an isoprenyl side chain comprising 4 to 13 isoprene units in 3-position and is generally called menaquinone. In humans, menaquinone-4 (menatetrenone) having 4 repeating structures of isoprenyl side chains is synthesized by bacteria in the intestinal canal to supply a portion of the requirement of vitamin K. These are substances necessary for synthesizing, in the liver, prothrombin which is a precursor of the enzyme (thrombin) causing a blood coagulation reaction, and are compounds of great importance as hemostatics promoting blood coagulation. Furthermore, these have an action to prevent release of calcium from the bones, therefore their application as therapeutic agents for osteoporosis is attracting attention.

From convenience points of view, these compounds having a quinone skeleton are preferably ingested together with other active ingredients, for example vitamins, amino acids, and the like described below. Therefore, particularly in the field of health foods, combined preparations comprising such a quinone skeleton-containing compound and other active components constitute the main stream of application these days. However, the preliminary investigation of such combined preparations, which had been undertaken by the present inventors, revealed that a composition comprising ubidecarenone in combination with any substance having antioxidation effect (antioxidant) such as vitamin C experiences a progressive decrease in ubidecarenone content in the composition although the degree of decrease varies depending on environments, formulations, and other conditions.

It is also to be noted that the antioxidant itself is decomposed under the above-mentioned conditions. For example, dehydroascorbic acids formed on decomposition of vitamins C (ascorbic acids), or oxalic acid formed on further decomposition thereof is highly toxic unlike ascorbic acids. For example, increases in mass of lipid peroxide and decreases in antioxidant substances in the liver and kidneys, and increases in oxalic acid in the kidneys have been reported, so that there are apprehensions for side effects such as decrease in resistance to oxidation stresses and a tendency toward development of ureterolithiasis (Nutrition Research, Vol. 13, 667-676, 1993) as well as problems in terms of product quality are liable to occur.

### SUMMARY OF THE INVENTION

In the above state of the art, the present invention has for its object to provide a method of stabilizing a compound having a quinone skeleton which, when used in the preparation of foods, functional nutritive foods, specified health foods, nutritional supplements, nutrients, veterinary drugs, beverages, feedstuff, cosmetic products, pharmaceutical products, therapeutic agents, preventive drugs, and the like, or a raw material and a composition comprising any of these, enables to stably retain the compound having a quinone skeleton even in a composition comprising both the compound having a quinone skeleton and an antioxidant and, further, to provide a stabilized composition.

As a result of intensive researches, the present inventors found that the compound having a quinone skeleton can be stably retained by coating at least one of the compound having a quinone skeleton and an antioxidant with an oil-insoluble coating medium to make both constituents coexist in an oily substance, or coating at least one of the compound having a quinone skeleton and an antioxidant with a water-insoluble coating medium to make both constituents coexist in an aqueous substance.

That is, the present invention relates to a method of stabilizing a compound having a quinone skeleton in a composition comprising a compound having a quinone skeleton and an antioxidant

which comprises coating at least one of the compound having a quinone skeleton and an antioxidant with an oil-insoluble coating medium to make both constituents coexist in an oily substance,

or coating at least one of the compound having a quinone skeleton and an antioxidant with a water-insoluble coating medium to make both constituents coexist in an aqueous substance.

The present invention further relates to a composition containing a compound having a quinone skeleton

which comprises a compound having a quinone skeleton and an antioxidant, and

at least one of said compound having a quinone skeleton and an antioxidant being coated with an oil-insoluble coating medium to make both constituents coexist in an oily substance or at least one of said compound having a quinone skeleton and an antioxidant being coated with a water-insoluble coating medium to make both constituents coexist in an aqueous substance.

### DETAILED DESCRIPTION OF THE INVENTION

The present invention is now described in detail.

According to the present invention, in a composition comprising a compound having a quinone skeleton and an antioxidant, the compound having a quinone skeleton, or preferably both the compound having a quinone skeleton and an antioxidant can be stably retained even in the composition comprising the compound having a quinone skeleton and an antioxidant being coexisted by coating at least one of the compound having a quinone skeleton and an antioxidant with an oil-insoluble coating medium to make both constituents coexist in an oily substance, or coating at least one of the compound having a quinone skeleton and an antioxidant with a water-insoluble coating medium to make both constituents coexist in an aqueous substance.

It is particularly preferable to coat at least one of the compound having a quinone skeleton and an antioxidant with an oil-insoluble coating medium to make both constituents coexist in an oily substance.

The composition comprising a compound having a quinone skeleton and an antioxidant of the present invention may be a combination of an antioxidant with a coated compound having a quinone skeleton or a combination of the compound having a quinone skeleton with a coated antioxidant. Needless to say, preferred is one in which both the compound having a quinone skeleton and an antioxidant are coated.

Herein, “both the compound having a quinone skeleton and an antioxidant are coated” used in this specification means that the compound having a quinone skeleton and an antioxidant are covered each independently or both together. Particularly preferably, the compound having a quinone skeleton and an antioxidant are covered each independently.

The coating referred in the present invention needs only to be such that a part of the surface of crystals and/or melt (inclusive of oil) of the compound having a quinone skeleton and/or an antioxidant are covered with a coating medium. In the case where either the compound having a quinone skeleton or an antioxidant is covered, the percentage of the covered surface area of the coated component is preferably not less than 50%, more preferably not less than 60%, still more preferably not less than 70%, especially preferably not less than 80%, and most preferably not less than 90%. In the case where both the compound having a quinone skeleton and antioxidant are coated, the percentage of the total covered surface area of the compound having a quinone skeleton and an antioxidant is preferably not less than 50%, more preferably not less than 60%, still more preferably not less than 70%, especially preferably not less than 80%, and most preferably not less than 90%. Needless to say, most preferably, the whole surface area of the compound having a quinone skeleton and/or an antioxidant is covered.

Firstly, the method of producing the coated compound having a quinone skeleton and an antioxidant is described.

As the compound having a quinone skeleton which can be used in the invention, there may be mentioned, compounds having a quinone skeleton in use for foods and/or pharmaceutical products such as benzoquinone, naphtoquinone, anthraquinone, and quinolinequinone. Needless to say, these compounds can be used regardless of whether the quinone is o-quinone or p-quinone. Preferred are ubiquinones, phylloquinone, menaquinones, menadione, pyrroloquinoline quinones, and the like, more preferred are ubiquinones, phylloquinone, menaquinones, and the like, and particularly preferred are ubidecarenone, phylloquinone and menatetrenone. These compounds having quinone skeletons can be used in a combination of two or more different species.

The compound having a quinone skeleton for use in the invention can be obtained by the conventionally known production processes such as synthesis, fermentation, and extraction from natural products, for example. Preferred are ones obtained by fermentation or extraction from natural products.

The antioxidants are not particularly restricted provided that they are acceptable for food/pharmaceutical product use, and include, for example, glutathione, L-cysteine, N-acetylcysteine, reduced α-lipoic acid, tocotrienol, vitamin E α-tocopherol) and ester derivatives thereof, vitamin C (ascorbic acid) and ester derivatives and salts thereof, erythorbic acid and ester derivatives and salts thereof, vitamin A and ester derivatives thereof, carotenoids, rutin, zeaxanthin, astaxanthin, lycopene, flavonoids, L-carnitine, acetyl-L-carnitine, propionyl-L-carnitine, magnesium, zinc, selenium, manganese, riboflavin, niacinamide, curcuminoids, proanthocyanidin extracted from grapeseed and pine bark, NADH (reduced nicotinamide adenine dinucleotide), NADPH (reduced nicotinamide adenine dinucleotide phosphate), resveratrol, bilberry extract, milk thistle extract, highly unsaturated fatty acids available on concentration of fish oil or the like, and the like.

Preferred are glutathione, L-cysteine, N-acetylcysteine, tocotrienol, vitamin E (α-tocopherol) and ester derivatives thereof, vitamin C (ascorbic acid) and ester derivatives and salts thereof, erythorbic acid and ester derivatives and salts thereof, vitamin A and ester derivatives thereof, carotenoides, rutin, astaxanthin, lycopene, flavonoid, L-carnithine, and the like. More preferred are vitamin E and ester derivatives thereof and vitamin C and ester derivatives and salts thereof.

Needless to say, the above antioxidants can be used as a mixture of two or more different species.

The coating medium for use in the invention is not particularly restricted. However, as the oil-insoluble coating medium, there may be mentioned, for example, gelatin having high, medium, or low gelation properties, sugar, gum arabic, sugar esters of higher fatty acids, tragacanth, pectin, pullulan, dried egg white, milk, shellac, curdlan, cellulose derivatives, casein, casein compounds, starch, and the like.

As the water-insoluble coating medium, there may be mentioned, for example, sugar esters of higher fatty acids, starch, shellac, and the like.

Preferred is said oil-insoluble coating medium, and particularly preferred are gelatin, sugar, gum arabic, pullulan, curdlan, cellulose derivatives, starch, and the like.

Needless to say, these may be used as a mixture of two or more different species.

It is to be noted that the water-insoluble/oil-insoluble coating medium as used in this specification refers to substances whose solubility at room temperature in the aqueous substance/oily substance described below of generally not higher than about 50% by weight, preferably not higher than about 40% by weight, more preferably not higher than about 30% by weight, still more preferably not higher than about 20% by weight, and particularly preferably not higher than about 10% by weight. Therefore, water-insoluble and oil-insoluble coating media such as sugar esters of higher fatty acids, starch and shellac can also be used.

Among the above-mentioned coating media, as the sugar, there may be mentioned, for example, glucose, fructose, lactose, maltose, starch sugar, mannitol, sorbitol, galactose, sucrose, dextrin, maltodextrin, and the like. Preferred are glucose, sucrose, dextrin, and maltodextrin. As starch, there may be mentioned corn starch, potato starch, sweet potato starch, wheat starch, and the like. Preferred is corn starch.

As the cellulose derivative, there may be mentioned, for example, methylcellulose, ethylcellulose, carboxymethylcellulose, hydroxypropylcellulose, hydroxyethylmethylcellulose, hydroxypropylmethylcellulose, crystalline cellulose, and the like. Preferred is methylcellulose.

As the sugar ester of higher fatty acids, there may be mentioned, for example, palmitic acid sucrose ester, and the like.

As the casein compound, there may be mentioned, for example, casein sodium, and the like.

Where necessary, emulsifiers such as polyvinyl alcohol, polyvinylpyrrolidone, glycerol fatty acid esters, higher alcohols, hydrogenated oils, alginic acid salts, phospholipids e.g. lecithins, sorbitan fatty acid esters, polyoxyethylene sorbitan fatty acid esters, polysorbates, α-tocopheryl polyethylene glycol succinate, and the like can be used in combination with the coating medium.

The ratio of said coating medium relative to the coated compound having a quinone skeleton and/or coated antioxidant is not particularly restricted but is generally not less than about 0.1 w/w %, preferably not less than about 1 w/w %, more preferably not less than about 5 w/w %, and particularly preferably not less than about 10 w/w %. The upper limit is generally about 90 w/w %, preferably about 80 w/w %, more preferably about 70 w/w %, particularly preferably about 60 w/w %, and most preferably about 50 w/w %. Generally, the range of about 0.1. to 90 w/w % is suitably accepted, but it is preferable to select the most appropriate weight ratio taking cost and other factors into consideration.

For preparing the coated compound having a quinone skeleton and/or coated antioxidant, the compound having a quinone skeleton and/or an antioxidant may be added to a solution or suspension of said coating medium, or a solution or suspension of the coating medium may be added to a solution or suspension of the compound having a quinone skeleton and/or an antioxidant. Needless to say, a solution or suspension of the compound having a quinone skeleton and/or an antioxidant and a solution or suspension of said coating medium may be mixed together.

In the cases where two or more different species of said antioxidant are used in combination, the respective species may be independently coated or said two or more species may be coated together as a mixture. Furthermore, in the cases where two or more different species of said compound having a quinone skeleton are used, each species may be independently coated or said two or more species may be coated together as a mixture.

The solvent for use in preparing said solutions or suspensions varies with the solubility of the compound having a quinone skeleton and/or an antioxidant and cannot be defined uniformly, but water, alcohols, hydrocarbons, esters, and the oils and fats described below can be mentioned as examples.

As the alcohols, there may be mentioned ethanol, isopropyl alcohol, and the like, for example. As the hydrocarbons, there may be mentioned hexane, heptane, toluene, and the like, for example. As the esters, there may be mentioned, ethyl acetate, isopropyl acetate, ethyl formate, and the like, for example.

The conditions of temperature, stirring, mixing, etc. in mixing the compound having a quinone skeleton and/or an antioxidant with said coating medium are not particularly restricted. However, in order to obtain pertinent dispersion, the system may be warmed and/or the stirring intensity or mixing power may be increased.

The method of drying the mixture of the compound having a quinone skeleton and/or an antioxidant with said coating medium is not particularly restricted but generally known drying methods using such as a spray dryer, drum dryer, freeze dryer, flow dryer, a spray dryer with a built-in fluidized bed, or vacuum dryer may be applied. Generally, the mixture is dried at normal pressure or under reduced pressure until the solvent content is reduced to not more than about 15 w/w %, preferably not more than about 10 w/w %, and more preferably not more than about 6 w/w %. It is also possible to use microwave for the drying.

The drying temperature is not particularly restricted and the mixture can be dried at not higher than room temperature. Generally, however, it is not lower than about 30° C., preferably not lower than 40° C. Needless to say, a drying method comprising drying the mixture in a short time at about 100° C. or even at higher temperature can also be preferably used.

The coated compound having a quinone skeleton and/or coated antioxidant thus obtained may be screened, where necessary, for separation of large grains or microfine particles, before, after or in the course of drying. The separation can be carried out by using the conventional methods such as one comprising using a sieve or air-flow classification. Needless to say, a pulverizing step may be incorporated separately. As is obvious, it is desirable to adjust spraying, drying, granulating and pulverizing conditions to recover ones in preferable particle size range. Said particle size range is not particularly restricted but is preferably about 10 μm to 1 mm.

The granulation can be carried out by the generally known methods using a flow granulator or the like. Whichever of the process comprising granulation after drying, drying after granulation, and concurrent drying and granulating can be used. Therefore, the method comprising spraying and adding a solution of said coating medium to the compound having a quinone skeleton and/or an antioxidant, and then, subjecting the resultant to drying and granulation can also be applied. By such drying and granulation, a part or whole of the compound having a quinone skeleton and/or an antioxidant can be covered.

By using the thus obtained coated compound having a quinone skeleton and/or coated antioxidant, the desired composition comprising said compound having a quinone skeleton and an antioxidant can be prepared.

The compound having a quinone skeleton and/or an antioxidant used herein may be a combination of an antioxidant with the coated compound having a quinone skeleton or a combination of the compound having a quinone skeleton with a coated antioxidant. Needless to say, a combination of the coated compound having a quinone skeleton with a coated antioxidant is also preferred. Preferably, the compound having a quinone skeleton is coated.

By coating the compound having a quinone skeleton and/or an antioxidant as mentioned above, it becomes possible to stabilize the compound having a quinone skeleton even in a composition comprising both being coexisted.

The compound having a quinone skeleton and an antioxidant, at least one of them being coated with an oil-insoluble coating medium, are made coexist in an oily substance, and the compound having a quinone skeleton and an antioxidant, at least one of them being coated with a water-insoluble coating medium, are made coexist in an aqueous substance. Needless to say, it is particularly preferable to select the coating medium taking the effect of other material or the like mentioned below into consideration.

As a mode of making the coated compound having a quinone skeleton and/or a coated antioxidant coexist in oily or aqueous substances, there may be mentioned, for example, a mode comprising adding and mixing the coated compound having a quinone skeleton and/or a coated antioxidant, and the like modes.

The oily substance referred to in this specification is not particularly restricted provided that it is a solvent which normally forms two layers with water, that is to say one forming two layers with water in the absence of a substance having an emulsifying effect, such as a surfactant. For example, there may be mentioned the oils and fats described below, hexane, ethyl acetate, and the like.

The aqueous substance is not particularly restricted provided it is a solvent which forms a single layer with water, and water, ethanol, and the like are included. Needless to say, a system composed exclusively of water, and a mixture of water with an organic solvent, such as ethanol, which forms a single layer are included.

In addition, the above solvents used in a solution or suspension for preparing the coated compound having a quinone skeleton and/or a coated antioxidant can also be used as oily substances or aqueous substances according to their properties.

The ratio of the compound having a quinone skeleton in the composition may be such amount that the effect and efficacy expected of the compound having a quinone skeleton are exhibited, and the ratio cannot be defined uniformly since it varies depending on the species of the compound having a quinone skeleton. However, based on the total composition, the ratio of said compound is, for example, not less than about 0.01% by weight, preferably not less than about 0.1% by weight, more preferably not less than about 1% by weight, still more preferably not less than about 5% by weight, and most preferably not less than about 10% by weight. The upper limit is generally about 99% by weight, preferably about 95% by weight, more preferably about 90% by weight, still more preferably about 85% by weight, particularly preferably about 80% by weight, and most preferably about 70% by weight.

The ratio of the antioxidant relative to the compound having a quinone skeleton is not particularly restricted provided that the effect and efficacy expected of the antioxidant can be exhibited. However, the weight ratio is, for example, generally not less than about 0.01 w/w %, preferably not less than about 0.1 w/w %, more preferably not less than about 1 w/w %, still more preferably not less than about 5 w/w %, and most preferably not less than about 10 w/w %. The upper limit is not more than about 1000 w/w %, preferably not more than about 500 w/w %, more preferably not more than about 300 w/w %, and most preferably not more than about 200 w/w %.

The substance which can be contained in the composition of the invention is not particularly restricted. However, in addition to the compound having a quinone skeleton and an antioxidant, there may be mentioned, for example, oils and fats, surfactants, glycerol, polyethylene glycol, water, ethanol, and the like.

In addition, these substances may be used as oily substances or aqueous substances according to their properties.

The oils and fats may be natural ones derived from animals and plants, or synthetic and modified oils and fats. More preferred are those acceptable for food or pharmaceutical use. For example, as vegetable oils and fats, there may be mentioned, for example, coconut oil, palm oil, palm kernel oil, linseed oil, camellian oil, brown rice germ oil, rapeseed oil, rice oil, peanut oil, corn oil, wheat germ oil, soybeen oil, perillan oil, cottonseed oil, sunflower seed oil, kapok oil, evening primrose oil, shea butter, sal fat, cacao butter, sesame oil, safflower oil, olive oil, and the like. As animal oils and fats, there may be mentioned, for example, lard, milk fat, fish oil, beef tallow, and the like. Moreover, there may also be mentioned modified oils and fats obtainable by the fractionation, hydrogenation, transesterificaiton, etc. of these natural oils and fats (e.g. hydrogenated oils). Needless to say, medium-chain fatty acid triglyceride (MCT) can also be used. Moreover, a mixture thereof may also be used.

As the medium-chain fatty acid triglyceride, there may be mentioned triglycerides of fatty acids each containing 6 to 12 carbon atoms, preferably 8 to 12 carbon atoms.

Among the above oils and fats, from the standpoint of the handling easiness, odor, or the like, vegetable, synthetic and modified oils and fats are preferred. These oils and fats are preferably selected in consideration of their prices, and stability and solubility with the compound having a quinone skeleton. For example, coconut oil, palm oil, palm kernel oil, rapeseed oil, rice oil, soybean oil, cottonseed oil, safflower oil, olive oil, MCT, etc. are preferred. And rice oil, soybean oil, rapeseed oil, safflower oil, MCT, etc. are particularly preferred.

As the surfactants, there may be mentioned, for example, partial glycerides of fatty acids, propylene glycol fatty acid esters, phospholipids, sucrose fatty acid ester, sorbitan fatty acid ester, polyoxyethylene sorbitan fatty acid ester, and the like.

As the partial glycerides of fatty acids, there may be mentioned, for example, monoglycerides and diglycerides of fatty acids each containing 6 to 18 carbon atoms, preferably 6 to 12 carbon atoms, and the like. As the propylene glycol fatty acid esters, there may be mentioned, for example, monoglycerides and diglycerides of fatty acids each containing 6 to 18 carbon atoms, preferably 6 to 12 carbon atoms, and the like.

As the phospholipids, there may be mentioned, for example, egg yolk lecithin, purified soybean lecithin, phosphatidylcholine, phosphatidylethanolamine, phosphatidylserine, sphingomyelin, dicetyl phosphate, stearylamine, phosphatidylglycerol, phosphatidic acid, phosphatidylinositolamine, cardiolipin, ceramidophosphorylethanolamine, ceramidophosphorylglycerol, and various mixtures of these.

Among the surfactants mentioned above, partial glycerides of fatty acids, phospholipid, sorbitan fatty acid esters, polyoxyethylene sorbitan fatty acid esters, and the like are particularly preferred.

The composition of the invention may be appropriately supplemented with other components in addition to said oils and fats, surfactants, glycerol, polyethyleneglycol, water, ethanol, or the like.

Such other components are not particularly restricted but may for example be excipients, disintegrating agents, lubricants, binders, coloring agents, agglomeration inhibitors, absorption promoters, dissolution aids, stabilizers, and the like. Needless to say, active components other than said compound having a quinone skeleton and said antioxidant may also be incorporated.

Where necessary and unless the effect of the invention is interfered, the above additives may be separately coated or coated together with said compound having a quinone skeleton and/or said antioxidant, with taking the effects of the additives into consideration.

The excipients mentioned above are not particularly restricted but there may be mentioned, for example, sucrose, lactose, glucose, said starch, mannitol, crystalline cellulose, calcium phosphate, calcium sulfate, and the like.

The disintegrating agents mentioned above are not particularly restricted but there may be mentioned, for example, starch, agar, calcium citrate, calcium carbonate, sodium hydrogen carbonate, dextrin, crystalline cellulose, carboxymethylcellulose, tragacanth, and the like.

The lubricants mentioned above are not particularly restricted but there may be mentioned, for example, talc, magnesium stearate, silica, and the like.

The binders mentioned above are not particularly restricted but there may be mentioned, for example, ethylcellulose, methylcellulose, hydroxypropylmethylcellulose, tragacanth, shellac, gelatin, gum arabic, polyvinylpyrrolidone, polyvinyl alcohol, polyacrylic acid, polymethacrylic acid, sorbitol, and the like.

The coloring agents mentioned above are not particularly restricted but there may be mentioned, for example, those permitted for addition to pharmaceutical products and foods, and the like.

The agglutination inhibitors mentioned above are not particularly restricted but there may be mentioned, for example, stearic acid, talc, light silicic acid anhydride, hydrous silicon dioxide, and the like.

The absorption promoters mentioned above are not particularly restricted but there may be mentioned, for example, higher alcohols, higher fatty acids, and the like.

The dissolution aids mentioned above are not particularly restricted but there may be mentioned, for example, organic acids such as fumaric acid, succinic acid, malic acid, and the like.

The stabilizers mentioned above are not particularly restricted but there may be mentioned, for example, benzoic acid, sodium benzoate, ethyl parahydroxybenzoate, bees wax, and the like.

As the active components other than the compound having a quinone skeleton and an antioxidant, there may be mentioned, for example, amino acids, vitamins, minerals, polyphenols, organic acids, sugars, peptides, proteins, and the like.

In the cases where an oil and fat is contained in the composition, the ratio of the oils and fats relative to the whole composition is not particularly restricted. However, from the standpoint of the viscosity, fluidity, etc. of the composition, it is, for example, generally not less than about 10% by weight, preferably not less than about 20% by weight, more preferably not less than about 30% by weight. The upper limit is generally about 99% by weight, preferably about 95% by weight, more preferably about 90% by weight, particularly preferably about 80% by weight, and most preferably about 70% by weight.

In the cases where a surfactant, glycerol, and/or polyethylene glycol are contained in the composition, the ratio of the surfactant, glycerol, and/or polyethylene glycol relative to the whole composition is generally not less than about 1% by weight, preferably not less than about 3% by weight, more preferably not less than about 5% by weight, and still more preferably not less than about 10% by weight. Moreover, the investigation conducted by the present inventors revealed that when the ratio of the surfactant contained in the composition is large, decomposition of the compound having a quinone skeleton is promoted. Therefore, the upper limit is generally not more than about 80% by weight, preferably not more than about 70% by weight, more preferably not more than about 60% by weight, and particularly preferably not more than about 50% by weight.

In the cases where water and/or ethanol is contained as the aqueous substance in the composition, the ratio of water and/or ethanol relative to the whole composition is generally not less than about 1% by weight, preferably not less than about 5% by weight, more preferably not less than about 10% by weight, particularly preferably not less than about 20% by weight, and most preferably not less than about 30% by weight. The upper limit is generally about 99.9% by weight, preferably about 99% by weight, more preferably about 95% by weight, particularly preferably about 90% by weight, and most preferably about 80% by weight.

By applying the above formulation, it becomes possible to obtain a composition in which the compound having a quinone skeleton can be stably retained despite the coexistence of the compound having a quinone skeleton and an antioxidant.

The thus obtained composition comprising the compound having a quinone skeleton and an antioxidant is preferably used in such applications as foods, functional nutritive foods, specified health foods, nutritional supplements, nutrients, veterinary drugs, beverages, feedstuff, cosmetic products, pharmaceutical products, therapeutic agents, preventive drugs, and the like. Moreover, the above composition comprising the compound having a quinone skeleton and an antioxidant can be used as it is but particularly for use in such applications as foods, functional nutritive foods, specified health foods, nutritional supplements, nutrients, veterinary drugs, beverages, feedstuff, pharmaceutical products, therapeutic agents, preventive drugs, etc., it can be further processed into forms suitable for oral administration such as capsules (e.g. hard capsules, soft capsules, microcapsules), tablets (inclusive of chewable tablets), syrups, and beverages. Furthermore, it can also be processed into forms suitable for use as creams, suppositories, tooth pastes, and the like. The particularly preferred forms are capsules, especially soft capsules.

The capsule base materials are not particularly restricted but include not only gelatins derived from cattle bone, cattle skin, porcine skin, fish skin, etc. but also other materials (e.g. thickening stabilizers such as products derived from seaweeds e.g. carrageenan, alginic acid, etc., and those derived from plant seeds e.g. locust bean gum, guar gum, etc.; manufacturing materials inclusive of cellulose derivatives; etc. which can be used as food additives).

The composition comprising the compound having a quinone skeleton and an antioxidant according to the invention, inclusive of the encapsulated composition described above, can be used, when appropriate, as an additive in the preparation of bread, pasta, Japanese zosui (porridge of rice and vegetables), boiled rice dishes, cakes, confectioneries, and the like. Of course, use in the preparation of other foods is not precluded.

The above composition comprising the compound having a quinone skeleton and an antioxidant, inclusive of its forms suitable for oral administration, can be expected to retain the compound having a quinone skeleton after a predetermined period of storage in the content ratio (the weight ratio of the compound after the predetermined storage period relative to the weight of said compound before storage) of not less than about 92% by weight, preferably not less than about 95% by weight, more preferably not less than about 97% by weight, particularly preferably not less than 98% by weight, and most preferably not less than 99% by weight. The storage period mentioned above is, for example, not less than one day, preferably not less than 1 week, more preferably not less than 1 month, still more preferably not less than half a year, particularly preferably not less than 1 year, and most preferably not less than 2 years.

In accordance with the invention, the compound having a quinone skeleton can be stably retained even in the composition comprising both the compound having a quinone skeleton and an antioxidant, and said composition can be easily produced, so that it can be used with great advantage in a variety of applications such as foods and other products for oral administration.

In accordance with the present invention, the compound having a quinone skeleton can be stably retained even the compound having a quinone skeleton and an antioxidant coexist.

In accordance with the present invention, the compound having a quinone skeleton can be stably retained even the compound having a quinone skeleton and an antioxidant coexist.

### BEST MODE FOR CARRYING OUT THE INVENTION

The following examples are intended to describe the present invention in further detail and should by no means be construed as defining the invention. In addition, the content ratios of ubidecarenone and menatetrenone in these examples were determined by the HPLC analysis described below, but the obtained ubidecarenone content does not define the purity limit in the present invention.

(Conditions of HPLC Analysis)

Ubidecarenone

Column: Symmetry C18 (product of Waters), 250 mm (length)×4.6 mm (inner diameter), mobile phase: C₂H₅OH:CH₃OH=4:3 (v:v), detection wavelength: 210 nm, flow rate: 1 ml/min., retention time of ubidecarenone: 13.3 min.

Menatetrenone

Column: Symmetry C18 (product of Waters), 250 mm (length)×4.6 mm (inner diameter), mobile phase: CH₃OH, detection wavelength: 210 nm, flow rate: 1 ml/min., retention time of menatetrenone: 11.2 min.

### EXAMPLES 1 TO 7

40 g of ubidecarenone crystals were put into an air-flow granulator, and spray-coated and granulated using solutions of the various coating media shown in Table 1. The resulting granules were dried in vacuo to give coated crystals of ubidecarenone. The particle diameters of the granules were 50 μm to 600 μm. Then, the granules were sieved to recover those having particle diameters of 255 μm to 500 μm. The solvent content in these granulated products was approximately 6 to 8%.

Air-Flow Granulator

Equipment: Flow Coater “MINI” manufactured by Freund Corporation
Spray dial: ON/OFF=0.5/0.5
Pulse jet dial: ON/OFF=0.5/0.5
Air-flow inlet temperature: 90° C.
Air-flow outlet temperature: result (about 40 to 50° C.)
Spray pressure: 0.7 to 1.0 kg/cm²
Air flow control dial: 60 to 80

Spray speed at spray ON: about 1 mL/min.

TABLE 1

| | | Level of use of |
|---|---|---|
| | | coating medium (g)/ |
| | Coating medium | solvent (mL) |
| Example 1 | Glucose | 4 g/40 mL (water) |
| Example 2 | Sucrose | 4 g/40 mL (water) |
| Example 3 | Dextrin | 4 g/40 mL (water) |
| Example 4 | Gelatin | 4 g/40 mL (water) |
| Example 5 | Dried egg white | 4 g/40 mL (water) |
| Example 6 | Corn starch | 4 g/40 mL (water) |
| Example 7 | Shellac | 8 g/19 mL (ethanol) |

### EXAMPLES 8 TO 10

40 g of menatetrenone crystals were put into an air-flow granulator, and spray-coated and granulated using solutions of the various coating media shown in Table 2. Further, the resulting granules were dried in vacuo to give coated crystals of menatetrenone. The particle diameters of the crystals were 50 μm to 600 μm. The solvent content in these granulated products was approximately 6 to 8%.

Air-Flow Granulator

Equipment: Flow Coater “MINI” manufactured by Freund Corporation
Spray dial: ON/OFF=0.5/0.5
Pulse jet dial: ON/OFF=0.5/0.5
Air-flow inlet temperature: 90° C.
Air-flow outlet temperature: result (about 40 to 50° C.)
Spray pressure: 0.7 to 1.0 kg/cm²
Air flow control dial: 60 to 80

Spray speed at spray ON: about 1 mL/min.

TABLE 2

| | | Level of use of |
|---|---|---|
| | | coating medium (g)/ |
| | Coating medium | solvent (mL) |
| Example 8 | Glucose | 4 g/40 mL (water) |
| Example 9 | Dextrin | 4 g/40 mL (water) |
| Example 10 | Gelatin | 4 g/40 mL (water) |

### EXAMPLES 11 TO 15

40 g each of antioxidants shown in Table 3 were put into an air-flow granulator, spray-coated and granulated using aqueous solutions of glucose (glucose/water=4 g/40 mL). Further, the resulting granules were dried in vacuo to give glucose-coated antioxidant crystals. The particle diameters of the crystals were 50 μm to 600 μm. The water content in these granulation products was approximately 6 to 8%.

Air-Flow Granulator

Equipment: Flow Coater “MINI” manufactured by Freund Corporation
Spray dial: ON/OFF=0.5/0.5
Pulse jet dial: ON/OFF=0.5/0.5
Air-flow inlet temperature: 90° C.
Air-flow outlet temperature: result (about 40 to 50° C.)
Spray pressure: 0.7 to 1.0 kg/cm²
Air flow control dial: 60 to 80

Spray speed at spray ON: about 1 mL/min.

TABLE 3

| | Antioxidant |
|---|---|
| Example 11 | L-ascorbic acid |
| Example 12 | L-ascorbyl palmitate |
| Example 13 | α-Tocopherol |
| Example 14 | Glutathione |
| Example 15 | N-acetylcysteine |

### EXAMPLES 16 TO 18

20 g each of ubidecarenones were suspended in 100 mL of water. Then, glucose in the amounts shown in Table 4 was dissolved in these suspensions. The suspensions were dried in vacuo at room temperature for 3 days. The resultants were pulverized and sieved to recover glucose-coated crystals of ubidecarenone having the particle size of 355 to 600 μm. These crystals were dried in vacuo at 20 to 40° C. for 1 day. The water content was all 7 to 13%.

TABLE 4

| | Weight of glucose (g) |
|---|---|
| Example 16 | 1.2 |
| Example 17 | 3 |
| Example 18 | 8 |

### EXAMPLE 19

20 g of gelatin was dissolved in 160 mL of water. To this gelatin aqueous solution was added with 20 g of ubidecarenone, and the mixture was emulsified using a homogenizer. Using a spray dryer, this emulsion was spray-dried (inlet temperature: 170° C.) to give gelatin-coated crystals of ubidecarenone. The water content of this product was 9%.

### EXAMPLES 20 TO 22

20 g each of gelatin was dissolved in 160 mL of water. To these gelatin aqueous solutions were added with 20 g of antioxidants shown in Table 5. (When L-ascorbic acid or L-ascorbyl palmitate was used as an antioxidant, 20 g of rapeseed oil was combinedly added.) Then, using a homogenizer, these solutions were emulsified. Using a spray dryer, these emulsions were spray-dried (inlet temperature: 170° C.) to give gelatin-coated crystals of the antioxidants. The water content of these products was all 6 to 10%.

TABLE 5

| | Antioxidant |
|---|---|
| Example 20 | L-ascorbic acid |
| Example 21 | L-ascorbyl palmitate |
| Example 22 | α-Tocopherol |

### EXAMPLES 23 TO 26, COMPARATIVE EXAMPLES 1 AND 2

1 g of gelatin-coated ubidecarenone and 1 g of gelatin-coated antioxidant were mixed with 30 g of mixture solutions of polyoxyethylene sorbitan monooleate/sorbitan monooleate/medium-chain fatty acid triglyceride/glycerol=65/5/25/5 (weight ratio). These solutions were stored at 40° C. in a nitrogen atmosphere. The species of ubidecarenone and antioxidant used and the ubidecarenone contents after one day of storage are shown in Table 6. The results obtained by using the uncoated ubidecarenone and antioxidant are also shown.

TABLE 6

| | | | Ubidecarenone |
|---|---|---|---|
| | Ubidecarenone | Antioxidant | content (%) |
| Example 23 | Example 19 | Example 20 | 98.5 |
| Example 24 | Example 19 | Example 21 | 97.1 |
| Example 25 | Example 19 | Example 22 | 99.9 |
| Example 26 | Example 19 | Uncoated L-ascorbic | 95.6 |
| | | acid | |
| Compar. Ex. 1 | Uncoated | Uncoated L-ascorbic | 77.6 |
| | | acid | |
| Compar. Ex. 2 | Uncoated | Uncoated L-ascorbyl | 57.6 |
| | | palmitate | |

### EXAMPLES 27 TO 32, COMPARATIVE EXAMPLE 3

1 g of coated ubidecarenone and 1 g of coated antioxidant were mixed with 30 g of mixed solutions of rapeseed oil/soybean lecithin=95/5 (weight ratio). These solutions were stored at 40° C. in a nitrogen atmosphere for 3 months. The species of ubidecarenone and antioxidant used and the ubidecarenone content ratios are shown in Table 7. The results obtained by using the uncoated ubidecarenone and antioxidant are also shown.

TABLE 7

| | | | Ubidecarenone |
|---|---|---|---|
| | Ubidecarenone | Antioxidant | content (%) |
| Example 27 | Example 1 | Example 11 | 100.0 |
| Example 28 | Example 1 | Example 13 | 99.9 |
| Example 29 | Example 3 | Example 11 | 100.0 |
| Example 30 | Example 19 | Example 11 | 99.9 |
| Example 31 | Example 1 | Uncoated α-tocopherol | 100.0 |
| Example 32 | Uncoated | Example 13 | 99.9 |
| Compar. Ex. 3 | Uncoated | Uncoated L-ascorbic | 91.6 |
| | | acid | |

### EXAMPLE 33

165 g of rapeseed oil, 10 g of hydrogenated oil, 5 g of lecithin, and 5 g of bees wax were mixed at 70° C. Then, 25 g of the glucose-coated ubidecarenone (22.7 g as ubidecarenone) obtained in Example 1 and 25 g of the glucose-coated L-ascorbic acid (22.7 g as L-ascorbic acid) obtained in Example 11 were added to prepare a composition comprising ubidecarenone and L-ascorbic acid. A soft gelatin capsule preparation was produced with 310 mg of this composition (corresponding to 30 mg of ubidecarenone) per capsule.

### EXAMPLE 34

145 g of rapeseed oil, 20 g of tetraglycerol monooleate, 10 g of hydrogenated oil, 5 g of lecithin, and 5 g of bees wax were mixed at 70° C. Then, 25 g of the glucose-coated ubidecarenone (22.7 g as ubidecarenone) obtained in Example 1 and 25 g of the glucose-coated α-tocopherol (22.7 g as α-tocopherol) obtained in Example 13 were added to prepare a composition comprising ubidecarenone and α-tocopherol. A soft gelatin capsule preparation was produced with 310 mg of this composition (corresponding to 30 mg of ubidecarenone) per capsule.

### EXAMPLE 35

10 g of gelatin was dissolved in 80 mL of water. To this gelatin aqueous solution was added with 10 g of menatetrenone, and the mixture was emulsified using a homogenizer. Using a spray-dryer, this emulsion was spray-dried (inlet temperature: 170° C.) to give gelatin-coated crystals of menatetrenone. The water content of the crystals was 10%.

### EXAMPLE 36

145 g of rapeseed oil, 20 g of tetraglycerol monooleate, 10 g of hydrogenated oil, 5 g of lecithin, and 5 g of bees wax were mixed at 70° C. Then, 40 mg of the gelatin-coated menatetrenone (20 mg as menatetrenone) obtained in Example 35 and 25 g of the glucose-coated L-ascorbic acid (22.7 g as L-ascorbic acid) obtained in Example 11 were added to prepare a composition comprising menateterenone and L-ascorbic acid. A soft gelatin capsule preparation was produced with 305 mg of this composition (corresponding to 30 μg of menatetrenone) per capsule.

1. A method of stabilizing a compound having a quinone skeleton in a composition comprising a compound having a quinone skeleton and an antioxidant which comprises coating at least one of said compound having a quinone skeleton and an antioxidant- with an oil-insoluble coating medium to make both constituents coexist in an oily substance,
or coating at least one of said compound having a quinone skeleton and an antioxidant with a water-insoluble coating medium to make both constituents coexist in an aqueous substance.

2. The method of stabilizing a compound having a quinone skeleton in a composition comprising a compound having a quinone skeleton and an antioxidant according to claim 1, wherein at least one of said compound having a quinone skeleton and an antioxidant is coated with an oil-insoluble coating medium to make both constituents coexist in an oily substance.

3. The method according to claim 1, wherein the compound having a quinone skeleton is coated with an oil-insoluble coating medium or a water-insoluble coating medium.

4. The method according to claim 1,
wherein the compound having a quinone skeleton is at least one species selected from the group consisting of ubiquinones, phylloquinone, menaquinones, menadione and pyrroloquinoline quinones.

5. The method according to claim 1,
wherein the compound having a quinone skeleton is at least one species selected from the group consisting of ubidecarenone, phylloquinone, and menatetrenone.

6. The method according to claim 1,
wherein the antioxidant is at least one species selected from the group consisting of glutathione, L-cysteine, N-acetylcysteine, reduced α-lipoic acid, tocotrienol, vitamin E (α-tocopherol) and an ester derivative thereof, vitamin C (ascorbic acid) and an ester derivative and salt thereof, erythorbic acid and an ester derivative and salt thereof, vitamin A and an ester derivative thereof, carotenoid, rutin, zeaxanthin, astaxanthin, lycopene, flavonoid, L-carnitine, acetyl-L-carnitine, propionyl-L-carnitine, magnesium, zinc, selenium, manganese, riboflavin, niacinamide, curcuminoids, proanthocyanidins, NADH, NADPH, resveratrol, a bilberry extract, a milk thistle extract, and a highly unsaturated fatty acid.

7. The method according to claim 6, wherein the antioxidant is at least one species selected from the group consisting of vitamin E and an ester derivative thereof, and vitamin C and an ester derivative and salt thereof.

8. The method according to claim 1,
wherein the oil-insoluble coating medium is at least one species selected from the group consisting of gelatin having high, medium or low gelatin properties, sugar, gum arabic, a sugar ester of higher fatty acids, tragacanth, pectin, pullulan, dried egg white, milk, shellac, curdlan, a cellulose derivative, casein, a casein compound, and starch.

9. The method according to claim 1,
wherein the water-insoluble coating medium is at least one species selected from the group consisting of starch, a sugar ester of higher fatty acids, and shellac.

10. The method according to claim 1,
wherein the oil-insoluble coating medium is at least one species selected from the group consisting of gelatin, sugar, gum arabic, pullulan, curdlan, a cellulose derivative, and starch.

11. The method according to claim 10, wherein the sugar is at least one species selected from the group consisting of glucose, sucrose, dextrin, and maltodextrin.

12. A composition containing a compound having a quinone skeleton
which comprises a compound having a quinone skeleton and an antioxidant, and
at least one of said compound having a quinone skeleton and an antioxidant being coated with an oil-insoluble coating medium to make both constituents coexist in an oily substance or at least one of said compound having a quinone skeleton and an antioxidant being coated with a water-insoluble coating medium to make both constituents coexist in an aqueous substance.

13. The composition according to claim 12, which comprises a compound having a quinone skeleton and an antioxidant, and at least one of said compound having a quinone skeleton and an antioxidant being coated with an oil-insoluble coating medium to make both constituents coexist in an oily substance.

14. The composition according to claim 12, wherein the compound having a quinone skeleton is coated with an oil-insoluble coating medium or a water-insoluble coating medium.

15. The composition according to claim 12, wherein the compound having a quinone skeleton is at least one species selected from the group consisting of ubiquinones, phylloquinone, menaquinones, menadione and pyrroloquinoline quinones.

16. The composition according to claim 12, wherein the compound having a quinone skeleton is at least one species selected from the group consisting of ubidecarenone, phylloquinone, menatetrenone and pyrroloquinoline quinones.

17. The composition according to claim 12, wherein the antioxidant is at least one species selected from the group consisting of glutathione, L-cysteine, N-acetylcysteine, reduced α-lipoic acid, tocotrienol, vitamin E (α-tocopherol) and an ester derivative thereof, vitamin C (ascorbic acid) and an ester derivative and salt thereof, erythorbic acid and an ester derivative and salt thereof, vitamin A and an ester derivative thereof, carotenoids, rutin, zeaxanthin, astaxanthin, lycopene, flavonoids, L-carnitine, acetyl-L-carnitine, propionyl-L-carnitine, magnesium, zinc, selenium, manganese, riboflavin, niacinamide, curcuminoids, proanthocyanidins, NADH, NADPH, resveratrol, a bilberry extract, a milk thistle extract, and a highly unsaturated fatty acid.

18. The composition according to claim 17,
wherein the antioxidant is at least one species selected from the group consisting of vitamin E and an ester derivative thereof, and vitamin C and an ester derivative and salt thereof.

19. The composition according to claim 12, wherein the oil-insoluble coating medium is at least one species selected from the group consisting of gelatin having high, medium or low gelation properties, sugar, gum arabic, a sugar ester of higher fatty acids, tragacanth, pectin, pullulan, dried egg white, milk, shellac, curdlan, a cellulose derivative, casein, a casein compound, and starch.

20. The composition according to claim 12, wherein the water-insoluble coating medium is at least one species selected from the group consisting of starch, a sugar ester of higher fatty acids, and shellac.

21. The composition according to claim 12, wherein the oil-insoluble coating medium is at least one species selected from the group consisting of gelatin, sugar, gum arabic, pullulan, curdlan, a cellulose derivative, and starch.

22. The composition according to claim 21, wherein the sugar is at least one species selected from the group consisting of glucose, sucrose, dextrin, and maltodextrin.

23. The composition according to claim 12, which further comprises other active component other than the compound having a quinone skeleton and an antioxidant.

24. A food, functional nutritive food, specified health food, nutritional supplement, nutrient, veterinary drug, beverage, feedstuff, cosmetic product, pharmaceutical products, therapeutic agent, and preventive drug which are obtainable by processing the composition according to claim 12.

25. A food, functional nutritive food, specified health food, nutritional supplement, nutrient, veterinary drug, beverage, feedstuff, pharmaceutical products, therapeutic agent, and preventive drug which are obtainable by processing the composition according to claim 12 into an oral administration form.

26. The food, functional nutritive food, specified health food, nutritional supplement, nutrient, veterinary drug, beverage, feedstuff, pharmaceutical products, therapeutic agent, and preventive drug according to claim 25, wherein the oral administration form is a capsule form.

27. The food, functional nutritive food, specified health food, nutritional supplement, nutrient, veterinary drug, beverage, feedstuff, pharmaceutical products, therapeutic agent, and preventive drug according to claim 25, wherein the capsule form is a soft capsule.
